(19) United States
(12) Patent Application Publication
(10) Pub. No.: US 2004/0217014 A1
(43) Pub. Date: Nov. 4, 2004

(54) Solar powered electrolysis of brackish water

(76) Inventors: Stanford R. Ovshinsky, Bloomfield Hills, MI (US); Srinivasan Venkatesan, Southfield, MI (US); Hong Wang, Troy, MI (US)

Correspondence Address: ENERGY CONVERSION DEVICES, INC., 2956 WATERVIEW DRIVE, ROCHESTER HILLS, MI, 48309, US

(21) Appl. No.: 10/726,849

(22) Filed: Dec. 3, 2003

Related U.S. Application Data
(62) Division of application No. 10/427,272, filed on May 1, 2003.
(63) Continuation-in-part of application No. 10/427,272, filed on May 1, 2003.

(51) Int. Cl. C02F 1/461

(52) U.S. Cl. 205/742; 204/278

(57) ABSTRACT

A photovoltaic driven electrolytic water desalination process is disclosed herein. The process utilizes electrical energy provided by a photovoltaic device, such as a triple junction amorphous silicon solar cell, to induce a water splitting reaction in brackish water. The photovoltaic device provides an electrical potential across an anode and a cathode in contact with the brackish water and the electrical potential induces the water splitting reaction. The water splitting reaction liberates oxygen gas and hydrogen gas from brackish water. Collection and subsequent recombination of the oxygen gas and hydrogen gas in a reaction chamber provides for the spontaneous formation of purer, non-brackish water. The recombination reaction of oxygen gas and hydrogen gas to form water is an exothermic process that liberates energy in the form of thermal energy and/or electrical energy. The energy produced may be provided as power to other processes or used to supplement the photovoltaic energy used in the water splitting reaction. In another embodiment, the hydrogen gas and oxygen gas formed from brackish water may be separately collected and utilized without recombination to form water. The instant invention thus provides a method for forming hydrogen gas from brackish water.

### CROSS REFERENCE TO RELATED APPLICATIONS

The present invention is a continuation-in-part of, and is entitled to the benefit of the earlier filing date and priority of, co-pending U.S. patent application Ser. No. 10/427,272, entitled “METHOD AND APPARATUS FOR ELECTROREFINING IMPURE HYDROGEN” filed May 1, 2003, which is assigned to the same assignee as the current application, and co-pending U.S. patent application Ser. No. 10/367,060, entitled “HYDROGEN INFRASTRUCTURE, A COMBINED BULK HYDROGEN STORAGE/SINGLE STAGE METAL HYDRIDE HYDROGEN COMPRESSOR THEREFOR AND ALLOYS FOR USE THEREIN”, filed Feb. 14, 2003, which is assigned to the same assignee as the current application, which is a continuation-in-part of U.S. patent application Ser. No. 09/902,320, now U.S. Pat. No. 6,591,616, which is a continuation-in-part of U.S. patent application Ser. No. 09/444,810, now U.S. Pat. No. 6,305,442, which is a continuation-in-part of U.S. patent application Ser. No. 09/435,497, now U.S. Pat. No. 6,193,929, all of the disclosures of which are hereby incorporated herein by reference.

### FIELD OF INVENTION

This invention generally relates to an apparatus and method of separation of water from aqueous solutions and suspensions having contaminants using solar energy. More specifically, this invention relates to the separation of water from brackish water to form desalinated water in an electrolytic process driven by solar energy. Most specifically, this invention relates to the use of solar energy to create an electric potential across electrodes to desalinate water through an electrolytic water splitting and recombination process to form clean water while leaving behind salt and other impurities.

### BACKGROUND OF THE INVENTION

Water is a precious and life sustaining liquid. Over 97% of the world water supplies are tied up in the ocean. The remaining 3% of the water exists as fresh water supply in natural and man-made lakes and the polar ice caps. With the looming environmental catastrophe brought upon by the global warming there is already a shortage of fresh water supply in the world. Many of the developing countries are suffering from the failure of the monsoon and consequently the supply of fresh water in reservoirs. The global warming is causing the ice caps to recede thereby melting the fresh water supplies at the polar ice caps into the water that runs into the oceans. While fossil fuels themselves are dwindling and wars have been waged to control the remaining residues it is possible to foresee a day when wars will be fought for control of fresh water supplies. The danger is not in any future date but can happen within our generation.

The general approaches for addressing water shortages can be categorized in terms of three basic strategies: conservation, identifying new sources of freshwater and converting brackish water to freshwater. The goal of water conservation is to promote responsible usage of water. Water conservationists seek to obtain the maximum benefit from existing freshwater sources through the encouragement of responsible usage practices. Although water conservation is clearly beneficial, it is unlikely that it alone will meet the growing water needs of the world. The identification of new sources of freshwater involves searching for new aquifers, typically to supply the growing needs of a particular region as it develops or expands. New technologies permit geologists to search deeper into the earth for water and to search in regions that were previously inaccessible. Other strategies for obtaining freshwater from new sources include extracting water from icebergs or the polar icecap. More controversially, growing regions with few local water resources are seeking a redistribution of the available resources through water transportation. The southwestern states, for example, have inquired into the possibility of shipping water from the Great Lakes to meet their water needs. Although the search for new freshwater resources will continue and new sources will be identified, it is clear that freshwater is a finite resource that is politically contentious and that the most accessible sources have already been located and are being consumed. Future sources will become increasingly expensive to both locate and utilize.

A third strategy, water conversion, seeks to produce freshwater from brackish water in an attempt to exploit the vast potential of the world's oceans. Water conversion is most commonly practiced today in arid regions, such as the Middle East, where little or no freshwater resources are naturally available. Conversion of brackish water to freshwater involves a desalination process in which freshwater or purified water is separated or extracted from brackish water. There are a variety of methods available already to convert brackish water into potable water. Evaporation and condensation, reverse osmosis, and electrodialysis are some of the very common techniques.

The most common desalination process in use today is based on reverse osmosis, a separation method that uses pressure to induce diffusion of water from brackish water through a semi-permeable membrane to provide pure water on one side of the membrane and concentrating salts and impurities on the other side of the membrane. Although reverse osmosis is an effective desalination technique, it is slow, expensive and requires high energy consumption. Related techniques, such as electrodialysis, show improved energy efficiency, but nonetheless remain costly, especially for high volume throughputs. Reverse osmosis and electrodialysis work very well with salt content under 60,000 ppm. Anything more than that would require higher pressures (close to 1000 psi) and the current membranes, in addition to being expensive cannot sustain such high pressures.

Evaporation/distillation is the preferred method. It is somewhat expensive but work is being performed to continuously decrease the cost by efficient designs.

The current invention overcomes deficiencies in the prior art and provides a novel method and apparatus for the desalination of brackish water, which incorporates a solar powered system that electrolytically dissociates brackish water into hydrogen gas and oxygen gas to eliminate impurities. The gaseous hydrogen and gaseous oxygen is combined to form water that may be used for human consumption or agricultural/industrial pursuits.

### SUMMARY OF THE INVENTION

The instant invention provides a method and apparatus for converting brackish water to freshwater. The method uses solar energy to produce electrical energy that is harnessed to separate pure water from brackish water through a water splitting reaction. Water splitting is a reaction in which liquid water is decomposed into hydrogen gas and oxygen gas. The change in phase from liquid to gas liberates hydrogen gas and oxygen gas from brackish water, thereby effecting a separation of hydrogen gas and oxygen gas from brackish water. Subsequent recombination of hydrogen gas and oxygen gas provides purified water. The hydrogen gas may also be separately captured and stored, if desired, for later use as a fuel. The liberation of hydrogen gas and oxygen gas leads to a concentration of salts and other impurities in the brackish water.

In the instant invention, solar energy is collected by a photovoltaic device and converted to electrical energy that is provided to brackish water through submerged electrodes. The electrical energy is sufficient to drive the water splitting reaction to liberate hydrogen gas and oxygen gas in an electrolytic process. The hydrogen gas and oxygen gas evolve from the brackish water and are collected in a remote chamber for reconversion to water. The reconverted water is substantially pure water that is free of brackish content. The reconversion process generates electrical energy that can be separately harnessed or directed to the splitting process to aid the photovoltaic process.

A preferred embodiment of the present invention comprises an apparatus for electrolytic purification of brackish water. The apparatus includes a photovoltaic device for converting solar energy to electricity, an anode in electrical communication with the photovoltaic device and a cathode in electrical communication with said photovoltaic device. Also, both the anode and cathode are in contact with the brackish water. The solar energy causes the generation of an electric potential between the anode and cathode and the electrical potential induces a water splitting reaction of the brackish water. The water splitting reaction produces hydrogen gas and oxygen gas, which evolve from the brackish water. The oxygen gas and hydrogen gas are transferred to a reaction chamber and the hydrogen gas and oxygen gas react spontaneously in the reaction chamber to form water. The apparatus may further include means for collecting the hydrogen gas and means for collecting the oxygen gas. Additionally, the apparatus may further include a hydrogen purification system for purifying the hydrogen gas before entering the reaction chamber.

An embodiment of the present invention comprises an apparatus for the production of hydrogen gas from brackish water. The apparatus includes a photovoltaic device for converting solar energy to electricity, an anode in electrical communication with the photovoltaic device and a cathode in electrical communication with said photovoltaic device. Also, both the anode and cathode are in contact with the brackish water. The solar energy causes the generation of an electric potential between the anode and cathode, the electrical potential inducing a water reduction reaction of the brackish water that produces hydrogen gas, which evolves from the brackish water. The apparatus may further include a hydrogen storage material, the hydrogen storage material absorbing and storing the hydrogen gas. Additionally, the apparatus may further include a hydrogen purification system for purifying the hydrogen gas before absorption into the hydrogen storage material.

A preferred embodiment of the present invention comprises a method for the electrolytic purification of brackish water. The method begins by contacting the brackish water with an anode and contacting the brackish water with a cathode, then applying an electrical potential across the anode and the cathode. The electrical potential is supplied by a photovoltaic device in electrical communication with the anode and the cathode. The electrical potential induces a water splitting reaction of the brackish water, producing hydrogen gas and oxygen gas, the hydrogen gas and said oxygen gas evolving from the brackish water. The hydrogen gas is transferred to a reaction chamber and the oxygen gas is transferred to the reaction chamber and the hydrogen gas and the oxygen gas react spontaneously in the reaction chamber to form water, H₂O. The method may further include collecting the hydrogen gas prior to transferring the hydrogen gas to the reaction chamber and collecting the oxygen gas prior to transferring the oxygen gas to the reaction chamber.

The photovoltaic device is preferably a silicon based device optimized for the efficient collection and conversion of sunlight to electricity. Optimally, the photovoltaic device is lightweight and in the form of a thin film that can be spread out adjacent to or over the surface of a source of brackish water.

An embodiment of the present invention provides an apparatus and method for the electrolysis of brackish water to liberate hydrogen gas and oxygen gas, which combine to produce fresh water, wherein power for the apparatus is supplied by a photovoltaic device.

An embodiment of the present invention provides an apparatus and method for the electrolytic reduction of brackish water to produce hydrogen gas, wherein power for the apparatus is supplied by a photovoltaic device.

### BRIEF DESCRIPTION OF THE DRAWINGS

In order to assist in the understanding of the various aspects of the present invention and various embodiments thereof, reference is now made to the appended drawings, in which like reference numerals refer to like elements. The drawings are exemplary only, and should not be construed as limiting the invention.

FIG. 1 is a fragmentary, cross-sectional view of a tandem or cascade photovoltaic device comprising a plurality of p-i-n-type cells, each layer of the cells formed from an amorphous silicon alloy material;

FIG. 2 is a schematic depiction of an embodiment of the electrolytic desalination apparatus of the present invention;

FIG. 3 is a schematic depiction of an embodiment of an electrolytic desalination apparatus of the present invention in an ocean environment;

FIG. 4 is a process flow diagram of an embodiment of the present invention, wherein the electrical potential induces a water splitting reaction to produce hydrogen gas and oxygen gas;

FIG. 5 is a process flow diagram of an embodiment of the present invention, wherein the electrical potential induces a water reduction reaction to produce hydrogen gas that is absorbed by and stored in a hydrogen storage material; and

FIG. 6 is an embodiment of a hydrogen purification system that may be used in conjunction with an embodiment of the present invention.

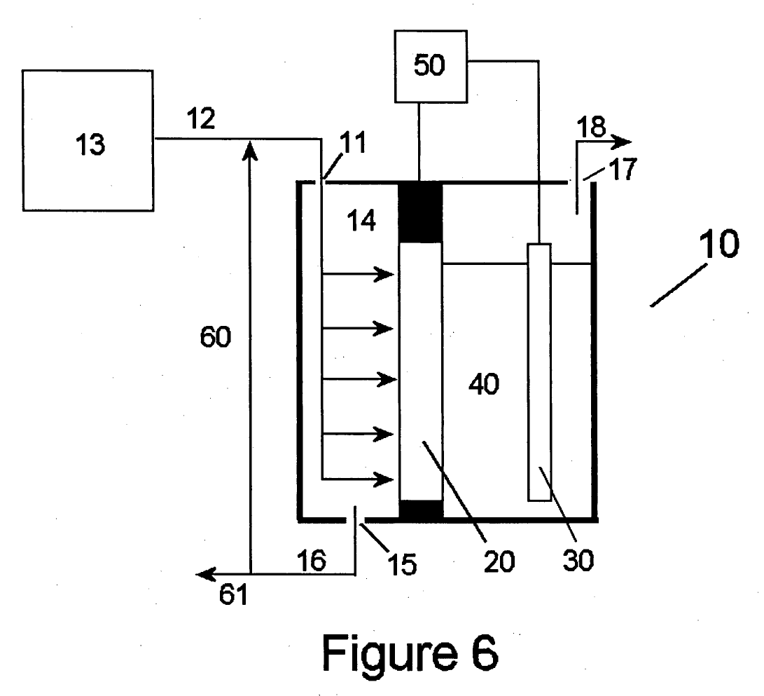

### DETAILED DESCRIPTION OF THE INVENTION

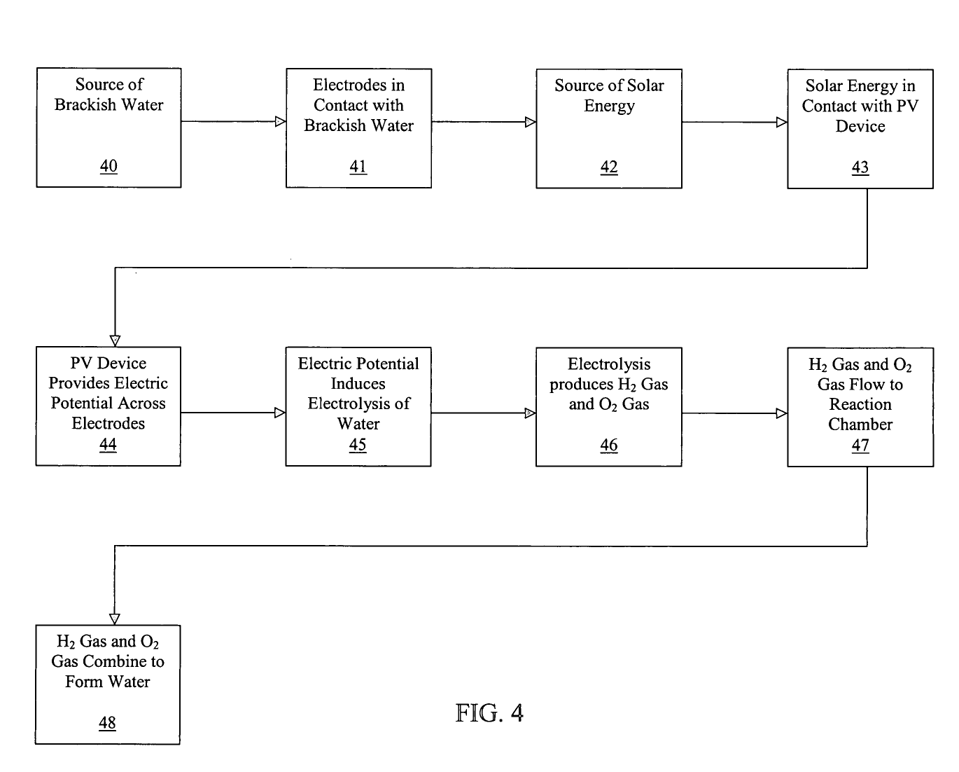

The instant invention is directed at the production of freshwater from brackish water. Brackish water refers generally to briny forms of water that are unsuitable for human consumption, agricultural and/or industrial uses. The oceans of the world are far and away the largest natural sources of brackish water. An objective of the instant invention is the separation or removal of water substantially without brackish content (e.g. dissolved or suspended salts or impurities) to provide a purer form of water. This purer form of water is suitable for human consumption, agriculture, and/or industrial use and may hereinafter be referred to as non-brackish water. Non-brackish water includes pure water as well as forms of water that include dissolved or suspended salts or compounds that are non-deleterious with respect to human consumption, agriculture or an industrial use. FIG. 4 is a flow diagram of an embodiment of the present invention. A source of brackish water, such as an ocean, is located 40 and electrodes, an anode and a cathode, are set in contact with the brackish water 41. A source of solar energy 42, i.e. sunlight, provides solar energy to a photovoltaic (PV) device 43 in electrical communication with the electrodes. The PV device provides an electric potential across the electrodes 44 and the electric potential induces electrolysis of water 45, i.e. H₂O, within the brackish water. The electrolysis produces hydrogen gas and oxygen gas 46. The gases flow to a reaction chamber 47, wherein the oxygen gas and hydrogen gas spontaneously combine to form water, H₂O 48.

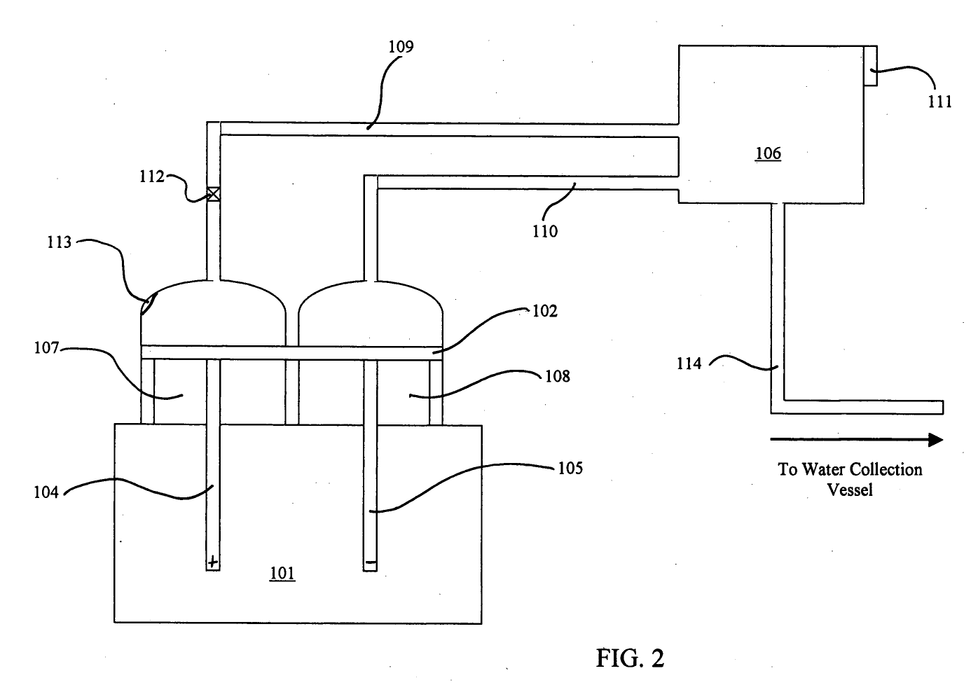

A schematic depiction of an apparatus for the production of non-brackish water from brackish water, generally referred to as 100, is presented in FIG. 2. The instant invention utilizes a renewable source of energy, sunlight, to effect the formation of non-brackish water from brackish water 101. Sunlight is collected by a photovoltaic device 102 and converted to electrical energy that is used to induce a water splitting (water electrolysis) reaction in brackish water 101. The brackish water 101 may be a source of brackish water, such as an ocean illustrated in FIG. 2, that is used in its natural setting to form non-brackish water according to the instant invention or the brackish water may be collected from a natural source and transported to a facility designed for the production of non-brackish water. The brackish water may also include chemically or physically pre-treated forms of natural brackish water. The photovoltaic device 102 may be placed into, on the surface of or adjacent to brackish water. The photovoltaic device 102 includes one or more materials that are capable of absorbing solar energy and converting it to electrical energy. The electrical energy produced by the photovoltaic device 102 is provided as an electrical potential to electrodes 104 and 105 that are in contact with the brackish water 101. The potential between the electrodes 104 and 105 of the photovoltaic device 102 is sufficient to drive an electrolytic water splitting reaction that liberates hydrogen gas and oxygen gas from the brackish water. The hydrogen gas and oxygen gas evolve from the brackish water 101, are collected, and directed toward a separate reaction chamber 106 where they are recombined to form non-brackish water.

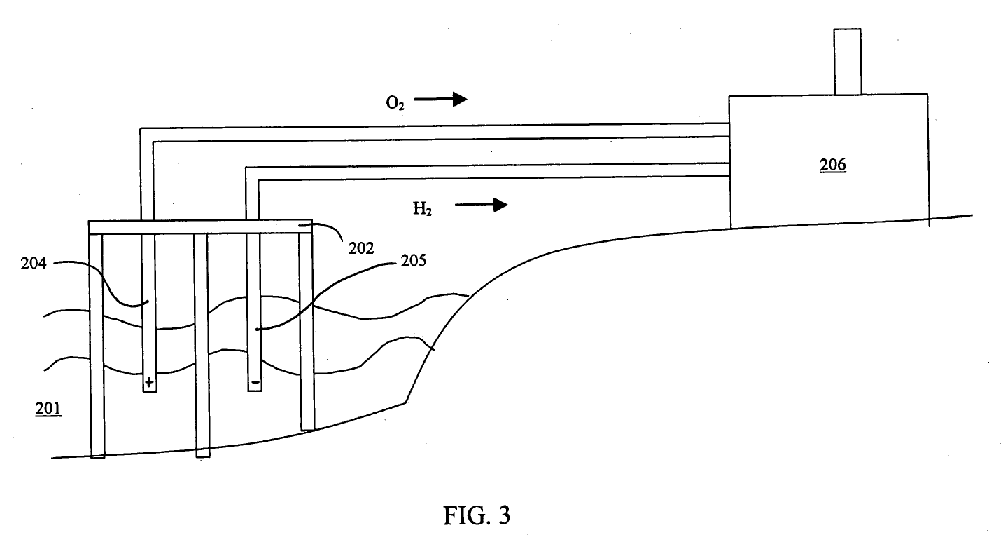

The gases may be collected using compartments 107 and 108 to collect the evolving gases as the gases bubble to the surface, as illustrated in FIG. 3. Preferably, an individual collection chamber is set over each of the electrodes 104 and 105. Once collected in the collection chambers, pipes or other conduits 109 and 110 may be utilized to transport the gases to the reaction chamber 106. A pump 111, such as diffusion pump, may be set in the gas conduits or reaction chamber 106 to assist in forcing the flow of oxygen gas and hydrogen gas into the reaction chamber 106. Preferably, the reaction chamber 106 is a vacuum-sealed chamber. If only hydrogen gas is desired to be collected, the oxygen gas may be vented into the atmosphere or collected for another purpose. For, example, a valve 112 in the oxygen conduit 109 may be set to close and an oxygen chamber vent 113 in the oxygen chamber 107 set to open in order to vent the oxygen gas. Another conduit 114 may be set at the bottom of the reaction chamber 106 to allow water to flow from the reaction chamber 106 to a water collection vessel.

The embodiment of the present invention illustrated in FIG. 3 is a preferred embodiment of the present invention, wherein the source of brackish water 201 is located in a cove fed by an ocean. A photovoltaic device 202 provides an electric potential to an anode and a cathode. A platform for the photovoltaic device and accompanying electrodes and conduits may be attached to the ocean floor or adapted to float on the water. As the electric potential across the electrodes 204 and 205 induces the electrolytic water splitting reaction, hydrogen gas and oxygen gas are liberated from the ocean and the concentration of other elements, such as salt, in the ocean water increases. However, as the tide ebbs and flows into the cove, new ocean water is swept into contact with the electrodes and the electrolytic water splitting reaction continues. Due to the vast expanse of earth's oceans, the oceans will retain the other elements but create a negligible overall effect in concentration of those elements. The hydrogen gas and oxygen gas may be collected and transported to a land facility 206, where the gases are combined to produce non-brackish water. The hydrogen gas and oxygen gas are combined in a reactor chamber located in the facility 206. If only hydrogen gas is to be collected, the oxygen may be vented into the atmosphere.

The photovoltaic device preferably utilizes a semiconductor as the active material. A preferred photovoltaic device structure for the instant invention is the n-i-p structure. This structure consists of an i-type (intrinsic) semiconductor layer interposed between an n-type semiconductor layer and a p-type semiconductor layer. In a typical simple device, a transparent conducting electrode layer is contacted to the p-type layer and a metal electrode is contacted to the n-type layer. In such a device, incident sunlight passes through the transparent electrode and p-type layer and is absorbed by the i-type layer. Absorption by the i-type layer leads to promotion of electrons from the valence band to the conduction band and to the formation of electron-hole pairs in the i-type layer. The electrons and holes are the charge carriers needed to produce electricity. The adjacent p-type and n-type layers establish a potential in the i-type layer that separates the electrons and holes. The electrons and holes are subsequently conducted to oppositely charged collection electrodes that provide the potential needed to induce the water splitting reaction.

Representative semiconductor materials suitable for the absorption of solar energy include crystalline silicon, polycrystalline silicon, amorphous silicon, microcrystalline silicon or related materials, including alloys of silicon with germanium. Other materials such as GaAs, CdS and CuInSe₂ may also be used. These materials can be prepared as n-type, i-type or p-type and have bandgap energies that permit absorption of at least a portion of the solar spectrum. Amorphous silicon is a preferred i-type material in a n-i-p structure because it possesses a direct bandgap and exhibits a high absorption strength over a wide wavelength range of the solar spectrum. The high absorbance of amorphous silicon is desirable because it leads to efficient absorption of sunlight in thinner devices. Thinner devices require less material and are correspondingly more cost effective.

A variety of n-i-p photovoltaic structures are operable to provide the electrical potential required to effect the water splitting reaction of the instant invention. A basic objective is to use a photovoltaic device structure that maximizes the absorption of solar energy and the conversion efficiency of solar energy to electrical energy. Several strategies for improving the performance of amorphous silicon based photovoltaic devices are possible. These strategies include the use of microcrystalline silicon to form the p-type layer, integration of two or more n-i-p structures to form tandem devices, and inclusion of a back reflector layer in the structure. U.S. Pat. No. 4,609,771, the disclosure of which is hereby incorporated herein by reference, discloses the use of microcrystalline silicon p-type layers in solar cells. The inventors therein demonstrate that microcrystalline silicon has a higher transparency to sunlight than amorphous silicon. As a result, use of a microcrystalline silicon p-type layer allows more incident sunlight to reach the i-type layer and a higher concentration of charge carriers is produced as a result. U.S. Pat. Nos. 4,600,801 and 5,977,476, the disclosures of which are hereby incorporated herein by reference.

The strategy associated with tandem devices is to couple multiple n-i-p structures in series in an attempt to harvest as much incident sunlight as possible. Although high, the absorption efficiency of i-type amorphous silicon layers is substantially less than 100%. Placement of a second n-i-p structure directly below the n-i-p structure that is directly incident to the sunlight provides an opportunity to capture light not absorbed by the first n-i-p structure. Tandem structures that include the stacking of three n-i-p structures to form triple cells have also been described. Additional strategies such as bandgap tailoring of the i-layer from one n-i-p structure to the next have also been demonstrated to improve the light harvesting efficiency of tandem structures. In these strategies, separate n-i-p structures in a tandem structure include i-type layers that are optimized to selectively absorb different portions of the solar spectrum. Amorphous silicon, for example, may be used to absorb the short wavelength portions of the solar spectrum, while SiGe alloys having various amounts of Ge may be used to absorb longer wavelengths since alloying with Ge reduces the bandgap. Representative triple cell structures are described in the following journal publications, the disclosures of which are hereby incorporated herein by reference: “Roll to roll manufacturing of amorphous silicon alloy solar cells with in situ cell performance diagnostics” by M. Izu and T. Ellison (Solar Energy Materials & Solar Cells vol. 78, p. 613-626 (2003)) and “Triple-junction amorphous silicon alloy solar cell with 14.6% initial and 13.0% stable conversion efficiencies” by J. Yang, A. Banerjee and S. Guha (Applied Physics Letters, vol. 70, p. 2975-2977 (1997)).

Back reflecting layers are reflective layers that are typically deposited directly on the substrate. The role of a back reflecting layer is to reflect any light passing through all of the n-i-p cells stacked in a tandem device. Through this reflection process, light that is initially not absorbed is redirected to the stacked n-i-p devices for a second pass and improved absorption efficiency results. Representative back reflecting layer materials include Al, ZnO, Ag, Ag/ZnO, and Al/ZnO.

An important advantage associated with amorphous silicon is the ability to manufacture it in a large scale continuous manufacturing process. Crystalline silicon, on the other hand, can only be prepared in a slow, smaller scale process because of the slow crystallization processes associated with its formation. Consequently, great efforts have been directed at the large scale production of amorphous silicon. Modern web rolling processes permit the high speed production of single and multilayer thin films amorphous silicon based devices. The production of amorphous silicon on a continuous web has been previously described in, for example, U.S. Pat. Nos. 4,485,125; 4,492,181; and 4,423,701, and U.S. application. Ser. No. 10/228,542 the disclosures of which are hereby incorporated herein by reference.

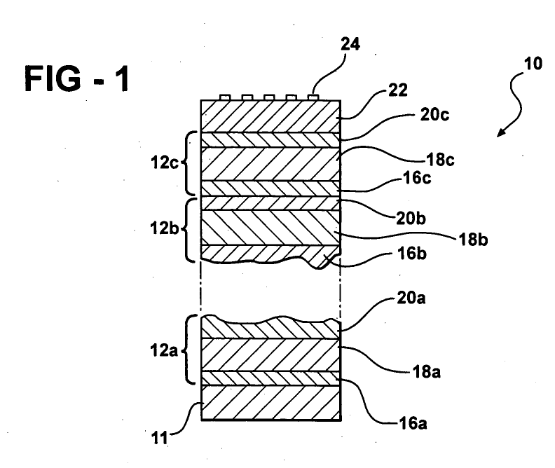

A p-i-n multiple cell device may be obtained by reversing the order of the n-plus and p-plus layers or regions of the n-i-p multiple cell device described above. Referring to FIG. 1, a tandem or cascade-type photovoltaic cell, formed of successive p-i-n layers each including an amorphous silicon alloy material, is shown generally by numeral 10. The photovoltaic device illustrated in FIG. 1 may be used with the present invention. FIG. 1 shows a p-i-n type photovoltaic device such as a solar cell made up of individual p-i-n type cells 12a, 12b and 12c. Below the lowermost cell 12a is a substrate 11 which may be transparent or formed from a metallic surfaced foil. The substrate material 11 may be stainless steel, aluminum, tantalum, molybdenum or chrome, as well as substrates formed of synthetic polymers, glass or glass-like material on which an electrically conductive electrode is applied.

Each of the cells 12a, 12b and 12c include an amorphous semiconductor body containing at least a silicon alloy. Each of the semiconductor bodies include an n-type conductivity region or layer 20a, 20b and 20c; an intrinsic region or layer 18a, 18b and 18c; and a p-type conductivity region or layer 16a, 16b and 16c. The term “amorphous” as used herein includes all materials exhibiting long-range disorder, regardless of their short or intermediate range order and regardless of whether those materials are otherwise labeled polycrystalline or crystalline. As illustrated, cell 12b is an intermediate cell and, as indicated in FIG. 1, additional intermediate cells may be stacked atop the illustrated cells.

For each of the cells 12a, 12b and 12c, the p-type and n-type layers of semiconductor material are characteristically light transmissive and highly conductive. The intrinsic layers of semiconductor material are characterized by an adjusted wavelength threshold for solar photoresponse, high light absorption, low dark conductivity and high photoconductivity, including sufficient amounts of a band gap adjusting element or elements to optimize the band gap for the particular cell application. Preferably, the intrinsic layers of semiconductor material are band gap adjusted to provide cell 12a with the lowest band gap, cell 12c with the highest band gap and cell 12b with a band gap between the other two, as light enters the semiconductor material from the top. However, the intrinsic layers of semiconductor material are band gap adjusted to provide cell 12a with the highest band gap, cell 12c with the lowest band gap and cell 12b with a band gap between the other two, if light enters the semiconductor material from the bottom. The n-type layers of semiconductor material are characterized by low light absorption and high conductivity. The thickness of the band gap adjusted layers of intrinsic material may be in the range of 800 to 5,000 angstroms. The thickness of the n-type and p-type layers may be in the range of 25 to 400 angstroms.

Placement of the electrodes of a photovoltaic device according to the instant invention in contact with brackish water provides an electric potential or voltage that is used to split water contained in the brackish water. The overall water splitting reaction is an electrolytic reaction given by

2H₂O(l)→2H₂(g)+O₂(g)

where the electrode half reactions are

2H₂O(l)→O₂(g)+4H⁺(aq)+4e⁻(anode; oxidation)

and

2H₂O(l)+2e⁻→H₂(g)+2OH⁻(aq) (cathode; reduction)

Since the water splitting reaction is not thermodynamically spontaneous, an electrochemical potential is needed to effect the reaction. At standard conditions, a minimum potential of 1.23 V is needed to drive the water splitting reaction. Potential above the minimum are preferable since they improve the rate of the reaction and compensate for any overvoltages that may be required to form oxygen gas or hydrogen gas. The tandem cell photovoltaic devices described hereinabove provide voltages at or above 1.23 V and typically provide voltages of at least 1.5 V.

Once the water splitting reaction is initiated, hydrogen gas and oxygen gas form and evolve from the brackish water. The hydrogen gas and oxygen gas can then be collected and later recombined in a reaction chamber to form non-brackish water. The collector may be a separate component that directly feeds the evolving hydrogen gas and evolving oxygen gas to a reaction chamber or may be an integral part of the reaction chamber. The collection of hydrogen gas and oxygen gas may occur separately since each gas is formed at different, spatially separated electrodes or both gases may be collected together. Once collected, hydrogen gas and oxygen gas can be reacted in a separate reaction chamber to form non-brackish water. Since the reaction of hydrogen gas and oxygen gas to form liquid water occurs spontaneously, the reaction releases energy in the form of heat and/or electrical energy. The heat or electrical energy so produced may be delivered as energy to other processes and may also be used to supplement the energy provided by the photovoltaic device in the water splitting reaction. Electrical energy produced by the reaction of oxygen gas and hydrogen gas can be extracted by equipping the reaction chamber with electrodes, where the reaction of hydrogen gas and oxygen gas causes an electric potential to develop between the electrodes. This electric potential represents a source of electrical energy that can be exploited.

Liberation of hydrogen gas and oxygen gas from brackish water according to the instant invention effects a separation of hydrogen and oxygen in a substantially pure form while leaving behind a more concentrated brackish solution. Recombination of the hydrogen gas and oxygen gas in a reaction chamber consequently results in a substantially pure form of water that is substantially desalinated and suitable for human consumption, agriculture and/or industrial use.

The efficiency of the water splitting reaction may depend on the particular composition of brackish water electroyzed in the instant process. Since brackish water is a naturally occurring substance, its composition varies from source to source. Differences in the identity and concentration of various dissolved salts occur for brackish water obtained from different sources. The presence of dissolved ions may introduce competing oxidation and/or reduction reactions that may impair the efficiency of the preferred water oxidation and reduction reactions listed hereinabove.

The presence of dissolved metal cations in brackish water may introduce reduction reactions that compete with the reduction of water to form hydrogen gas. Metal cation reduction reactions become more competitive as the activity of the metal decreases. Cations of the less active metals (e.g. Au³⁺, Ag⁺, Cu²⁺, Fe³⁺, Cd²⁺, and Pt²⁺) have reduction reactions that are more competitive with the water reduction reaction than do cations of the more active metals (e.g. alkali metals, alkaline earth metals, Al³⁺). The instant solar induced electrolytic water desalination process is therefore preferably employed on brackish water that includes a low concentration of the less active metals. Half cell reduction potentials of the cations present in a particular sample of brackish water in conjunction with well established electrochemical theory, including overvoltage effects, can be employed to predict the likelihood of efficient hydrogen gas production from the particular sample of brackish water in the instant electrolytic process.

The presence of dissolved anions in brackish water may introduce oxidation reactions that compete with the oxidation of water to form oxygen gas. The halides Br⁻, I⁻, and Cl⁻, if present in sufficient amounts, undergo competitive oxidation reactions to form the gaseous dihalides Br₂, I₂, and Cl₂. Oxoanions such as SO₄²⁻, CO₃²⁻, NO₃⁻, and PO₄³⁻ that include a non-metal in a high oxidation state, in contrast, exhibit little or no tendency to undergo a competitive oxidation reaction and their presence in brackish water does not materially hinder the water oxidation reaction. The relative ease of oxidation of anions in brackish water in comparison to water oxidation governs the efficiency of the production of oxygen gas from brackish water. Half cell oxidation potentials of the anions present in a particular sample of brackish water in conjunction with well established electrochemical theory, including overvoltage effects, can be employed to predict the likelihood of efficient oxygen gas production from the particular sample of brackish water in the instant electrolytic process.

As indicated hereinabove, hydrogen gas and oxygen gas form at different, spatially separated electrodes and may be separately collected. As a result, the instant electrolytic process may also be used to produce hydrogen gas and/or oxygen gas without recombination to form non-brackish water. The instant electrolytic process may also be used to produce one of hydrogen gas or oxygen gas when the brackish water content contains cations or anions that interfere with or out-compete water oxidation or reduction. If brackish water includes cations that are reduced more efficiently than water, the water reduction reaction to form hydrogen gas may not occur efficiently, but the brackish water may still be suitable for efficient production of oxygen gas. Similarly, if the brackish water includes anions that are more efficiently oxidized than water, the water oxidation reaction to form oxygen gas may not occur efficiently, but the brackish water may nonetheless be suitable for the efficient production of hydrogen gas.

As an example of the foregoing, hydrogen may be produced through the photochloralkali reaction when the chloride ion concentration of brackish water is sufficiently high. The photochloralkali reaction is given by

2H₂O(l)+2Cl⁻(aq)→2OH⁻(aq)+Cl₂(g)+H₂(g)

where the half cell reactions are

2Cl⁻(aq)→Cl₂(g)+2e⁻(anode; oxidation)

and

2H₂O(l)+2e⁻→H₂(g)+2OH⁻(aq)(cathode; reduction)

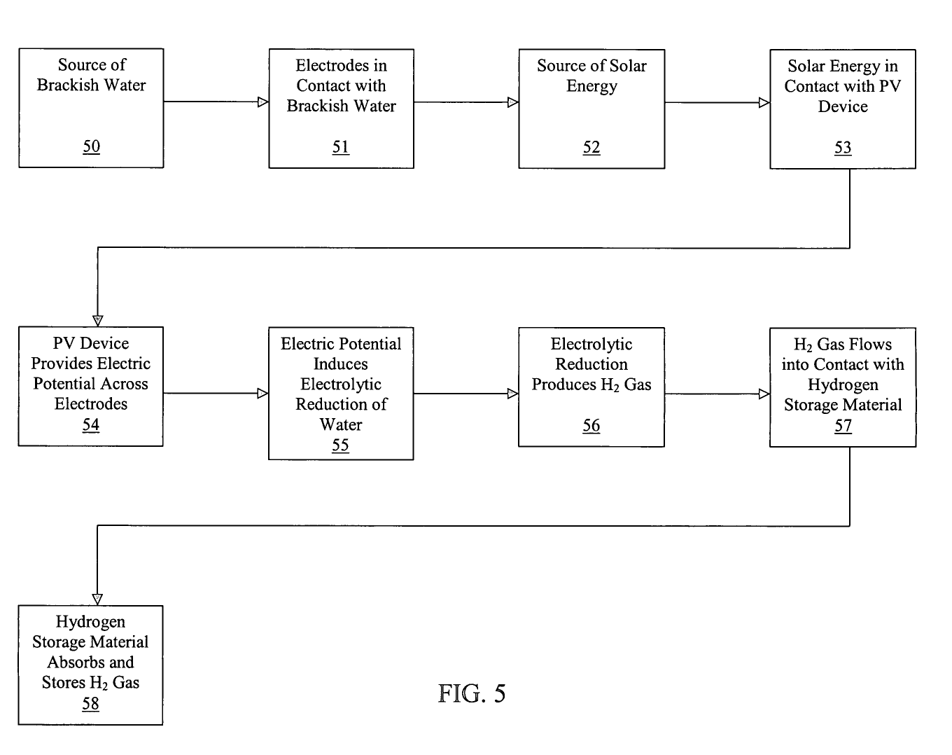

At sufficiently high chloride concentration, the formation of chlorine gas becomes increasingly efficient and may out-compete the oxidation of water to form oxygen gas. The formation of hydrogen gas, however, through water reduction may remain efficient. The photochloralkali reaction is thus an example of the formation of hydrogen gas from brackish water having a composition that inhibits or precludes the formation of oxygen gas. FIG. 5 is a flow diagram of an embodiment of the present invention. A source of brackish water, such as an ocean, is located 50 and electrodes, an anode and a cathode, are set in contact with the brackish water 51. A source of solar energy 52, i.e. sunlight, provides solar energy to a photovoltaic (PV) device 53 in electrical communication with the electrodes. The PV device provides an electric potential across the electrodes 54 and the electric potential induces electrolytic reduction of water 55, i.e. H₂O, within the brackish water. The electrolysis produces hydrogen gas 56. The hydrogen gas flows in to hydrogen storage material 57 and the hydrogen storage material absorbs and stores the hydrogen gas 58.

Hydrogen gas produced according to the instant photovoltaic electrolytic process may be used as a fuel for fuel cells, hydrogen engines, etc. Use of hydrogen as a fuel requires storage of hydrogen in a convenient form with an ability to retrieve the hydrogen for later combustion or consumption. In an embodiment of the instant invention, hydrogen produced in the instant photovoltaic electrolytic process is collected and stored in a hydrogen storage material. A hydrogen storage material is a metal alloy having a capacity to store hydrogen on its surface or within its interior. A wide variety of hydrogen storage materials is known in the art. Leading hydrogen storage materials include the A₂B, AB₂ and AB₅ families of materials. The instant inventor has invented, individually and jointly, a number of highly effective hydrogen storage materials. These materials include one or more transition metals (e.g. Zr, Fe, Ni, Mg, Ti, V, Cr, Mn, Co) or alloys thereof as well as alloys of transition metals with rare earth metals (e.g. La, mischmetal, Nd, Pr, Ce). Representative hydrogen storage materials are described, for example, in U.S. Pat. Nos. 6,193,929; 6,328,821; 6,517,970; 6,536,487; 5,536,591 and 6,270,719; the disclosures of which are hereby incorporated herein by reference.

The instant invention may be used in conjunction with a hydrogen purification system to purify the hydrogen gas of the water splitting reaction or the water reduction reaction. An exemplary hydrogen purification system is disclosed in co-pending U.S. patent application Ser. No. 10/427,272, entitled “METHOD AND APPARATUS FOR ELECTROREFINING IMPURE HYDROGEN” filed May 1, 2003, which is hereby incorporated herein by reference. The '272 application discloses an invention which provides a method and system for purifying an impure hydrogen stream containing any number of gaseous contaminants. In a preferred embodiment of the present invention, the hydrogen gas produce by electrolysis of the brackish water flows to an inlet of the hydrogen purification system of the '272 application. Referring to FIG. 3, the system 10 includes an input 11 for receiving an impure hydrogen stream 12 from a source of impure hydrogen 13, a gas receiving chamber 14, an output 15 for venting a contaminant rich gas stream 16 out of the gas receiving chamber 14, and an output 17 for providing a purified hydrogen stream 18. The purified hydrogen stream is then sent to the reactor chamber to combine with oxygen gas to produce purified water. The hydrogen purification system of the '272 application also includes at least one gas diffusion anode 20, at least one electrolytic cathode 30, and a power source 50 for supplying power to the electrodes. The power source 50 may be any means for supplying an electrical current such as a battery, a power outlet, or a generator. The power source 50 may also be a generator powered by the combustion of the contaminant gases contained in the impure hydrogen stream such as methane (CH₄) or other hydrocarbons. The power source may also be supplemented by an electrical current supplied from the gas diffusion anode. Both the anode and cathode of the hydrogen purification system of the '272 application are positioned in an alkaline solution bath 40, which may be comprised of a 15 to 30 weight percent KOH solution. The hydrogen purification system of the '272 application operating temperature is in the range of 70° C. to 90° C.

The gas receiving chamber comprises an input for receiving the gaseous stream of impure hydrogen and an output for venting an outlet stream containing contaminants from the stream of impure hydrogen and hydrogen not absorbed by said gas diffusion anode. The outlet stream may also be fed into a hydrogen separator adapted to separate the outlet stream into a hydrogen stream containing mostly hydrogen and a waste stream containing mostly contaminants. The resulting hydrogen stream may then be fed into the impure hydrogen stream and the waste stream may be vented to the atmosphere or collected. For a more detailed explanation of a hydrogen purification system, please refer to the '272 application.

During the electrolysis of the water, some water may be converted to water vapor and caught in the stream of hydrogen gas flowing form the cathode. In a preferred embodiment, a condenser may be incorporated to remove the water vapor from the hydrogen stream.

The foregoing is provided for purposes of explaining and disclosing preferred embodiments of the present invention. It will be apparent to those skilled in the art that variations and modifications of the present invention can be made without departing from the scope or spirit of the invention. For example, changes in the type of photovoltaic device, the type of hydrogen storage alloy and position of the electrodes, will be apparent to those skilled in the art. These changes and others may be made without departing from the scope or spirit of the invention in the following claims.

We claim:

1. An apparatus for electrolytic purification of brackish water, said apparatus comprising:
a photovoltaic device, said photovoltaic device converting solar energy to electricity, said photovoltaic device comprising at least one triple junction solar cell;
an anode in electrical communication with said photovoltaic device and said anode in contact with said brackish water,
a cathode in electrical communication with said photovoltaic device and said a cathode in contact with said brackish water, said solar energy causing the generation of an electric potential between said anode and said cathode; said electrical potential inducing a water splitting reaction of said brackish water, said water splitting reaction producing hydrogen gas and oxygen gas, said hydrogen gas and said oxygen gas evolving from said brackish water; and
a reaction chamber, said reaction chamber receiving said hydrogen gas and said oxygen gas, said hydrogen gas and said oxygen gas reacting spontaneously in said reaction chamber to form water.

2. The apparatus of claim 1, further comprising means for collecting said hydrogen gas and means for collecting said oxygen gas.

3. The apparatus of claim 2, said means for collecting said hydrogen gas comprising a hydrogen gas conduit, said hydrogen gas conduit collecting said hydrogen gas and transporting said hydrogen gas to said reaction chamber, said means for collecting said oxygen gas comprising a oxygen gas conduit, said oxygen gas conduit collecting said oxygen gas and transporting said oxygen gas to said reaction chamber.

4. The apparatus of claim 1, said brackish water comprising ocean water.

5. The apparatus of claim 1, said electrical potential comprising at least 1.23 V.

6. The apparatus of claim 1, further comprising a hydrogen purification system, said hydrogen purification system purifying said hydrogen gas.

7. The apparatus of claim 6, said hydrogen purification system comprising:
a gas receiving chamber adapted to receive a gaseous stream of impure hydrogen, said gaseous stream of impure hydrogen comprising said hydrogen gas produced from said brackish water;
an alkaline solution;
a source of power for providing an electrical current;
a gas diffusion anode adjacent to said gas receiving chamber having a gas interface in contact with said gaseous stream of impure hydrogen and an electrolyte interface in contact with said alkaline solution, wherein hydrogen from said gaseous stream of impure hydrogen is absorbed into said gas diffusion anode;
an electrolytic cathode in contact with said alkaline solution adapted to receive said electrical current and to produce a supply of hydrogen upon receipt of said electrical current.

8. The apparatus of claim 7, said gas receiving chamber comprising:
an input for receiving said gaseous stream of impure hydrogen; and
an output for venting an outlet stream containing contaminants from said stream of impure hydrogen and hydrogen not absorbed by said gas diffusion anode.

9. The apparatus of claim 8, said outlet stream fed into a hydrogen separator adapted to separate said outlet stream into a hydrogen stream containing mostly hydrogen and a waste stream containing mostly contaminants.

10. The apparatus of claim 9, said hydrogen stream fed into said impure hydrogen stream and said waste stream is vented to the atmosphere or collected.

11. The apparatus of claim 1, said triple junction solar cell comprising a triple junction amorphous silicon solar cell.

12. The apparatus of claim 1, said reaction chamber having reaction chamber electrodes, said spontaneous reaction causing an electric potential to develop between said reaction chamber electrodes.

13. The apparatus of claim 12, said electric potential of said reaction chamber electrodes providing electrical energy to said brackish water.

14. An apparatus for the production of hydrogen gas from brackish water, said apparatus comprising:
a photovoltaic device, said photovoltaic device converting solar energy to electricity, said photovoltaic device comprising at least one triple junction solar cell;
an anode in electrical communication with said photovoltaic device and said anode in contact with said brackish water,
a cathode in electrical communication with said photovoltaic device and said a cathode in contact with said brackish water, said solar energy causing the generation of an electric potential between said anode and said cathode; said electrical potential inducing a water reduction reaction of said brackish water, said water reduction reaction producing hydrogen gas, said hydrogen gas evolving from said brackish water.

15. The apparatus of claim 14, further comprising a hydrogen storage material, said hydrogen storage material absorbing said hydrogen gas, said hydrogen storage material storing said hydrogen gas.

16. The apparatus of claim 15, said hydrogen storage material comprising A₂B, AB₂, AB₅ or a mixture thereof.

17. A method for the electrolytic purification of brackish water, comprising:
contacting said brackish water with an anode;
contacting said brackish water with a cathode;
applying an electric potential across said anode and said cathode, said electric potential supplied by a photovoltaic device in electrical communication with said anode and said cathode, said electric potential inducing a water splitting reaction of said brackish water, said water splitting reaction producing hydrogen gas and oxygen gas, said hydrogen gas and said oxygen gas evolving from said brackish water;
transferring said hydrogen gas to a reaction chamber;
transferring said oxygen gas to said reaction chamber, said hydrogen gas and said oxygen gas reacting spontaneously in said reaction chamber to form water.

18. The method of claim 17, further comprising:
collecting said hydrogen gas prior to transferring said hydrogen gas; and
collecting said oxygen gas prior to transferring said oxygen gas.

19. The method of claim 17, further comprising purifying said hydrogen gas prior to transferring said hydrogen gas.

20. The method of claim 17, said electrical potential comprising at least 1.23 V.
